(19) United States
(12) Patent Application Publication
(10) Pub. No.: US 2006/0011577 A1
(43) Pub. Date: Jan. 19, 2006

(54) Method for post-treatment of semi-finished product after dry etching process

(75) Inventors: Li-Feng Chiu, Miao-Li (TW); Sheng-Chou Gau, Miao-Li (TW); Jung-Lung Huang, Miao-Li (TW); Chen-Hsien Ou, Miao-Li (TW); Chang Kuei Huang, Miao-Li (TW); Ching Feng Chen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/173,389

(22) Filed: Jun. 30, 2005

(30) Foreign Application Priority Data
Jul. 16, 2004 (CN) 2004100281904

(51) Int. Cl. B44C 1/22

(52) U.S. Cl. 216/58; 216/79; 216/41

(57) ABSTRACT

A post-treatment method of a semi-finished product after a dry etching process includes the steps of: providing the semi-finished product after completion of a dry etching process, the semi-finished product having a residue formed during the dry etching process; placing the semi-finished product in a chamber having an inlet and an outlet; introducing an SF₆ gas into the chamber via the inlet to effect a reaction between the SF₆ gas and the residue so as to produce a reaction gas; and discharging any remaining SF₆ gas and the reaction gas out of the chamber via the outlet. The SF₆ gas can completely react with the residue from the dry etching process and results residue gas pumped out by a vacuum system. It can entirely eliminate the residue over the contact hole and on the inside surface of the dry etching chamber, and can avoid electrical connection errors and improve the efficiency of manufacture. It also can clean the dry etching chamber and prolong the use life of the dry etching chamber.

### FIELD OF THE INVENTION

The present invention generally relates to a post-treatment method which is carried out after a dry etching process in semiconductor manufacturing, and more particularly to a method for post-treatment of a semi-finished product after completion of a dry etching process for removing a residue formed during the dry etching process.

### GENERAL BACKGROUND

Dry etching techniques are widely used in the semiconductor industry. Usually, a process for manufacturing a semiconductor generally includes the steps of coating a photo resist layer on a semiconductor layer that is formed on a substrate, exposing the photo resist layer using a mask and developing the photo resist layer to form a pattern on the photo resist layer, etching the semiconductor layer by a dry etching process using a gas containing for example oxygen (O₂), sulfur hex fluoride (SF₆) and carbon tetrafluoride (CF₄), and removing the remaining photo resist to form a patterned semiconductor layer.

However, a lot of residues such as polymers are often formed on the semiconductor layer during the dry etching process. These may cause faulty electrical connections in the finished semiconductor product. Therefore, a HF acid solution generally has to be utilized to remove the residues. Alternatively, the residues may be removed by way of ultraviolet radiation. However, the above-described methods increase costs. In order to economize on cleaning, another method commonly referred to as an ash treatment process has been developed.

FIG. 11 to FIG. 13 show a conventional process for ash treatment of a semi-finished product after a dry etching process. As shown in FIG. 11, a semi-finished product is provided. The semi-finished product includes a silicon oxide substrate 1, a silicon oxide layer 2 formed on the silicon oxide substrate 1, and a patterned photo resist layer 3 formed on the silicon oxide layer 2.

As shown in FIG. 12, the silicon oxide layer 2 is etched by a gas containing CF₄ and trifluoromethane (CHF₃) so as to remove a part of the silicon oxide layer 2 which is not covered by the photo resist layer 3. However, an unwanted fluorocarbon layer 6 is also formed in this process.

The treated substrate is then placed into a chamber, for performing of an ash treatment process using a plasma of O₂. As shown in FIG. 13, the fluorocarbon layer 6 and the photo resist layer 3 are removed by the ash treatment process, with the silicon oxide substrate 1 and the silicon oxide layer 2 remaining.

By using the plasma of O₂ to remove the fluorocarbon layer 6 and the photo resist layer 3 at the same time, the processing process is simplified, and the costs are reduced.

However, during the ash treatment process, the plasma of O₂ is generally incapable of removing the fluorocarbon completely. Therefore the remaining fluorocarbon residue and other polymers may still cause faulty electrical connections in the finished semiconductor product. Moreover, the polymer residues may also contaminate the chamber. Accordingly, the chamber may need to be cleaned unduly frequently.

What is needed, therefore, is a method for post-treatment of a semi-finished product after a dry etching process to remove residues formed during the dry etching process, such method overcoming the above-described deficiencies.

### SUMMARY

In a preferred embodiment, a post-treatment method of a semi-finished product after a dry etching process includes the steps of: providing the semi-finished product after completion of a dry etching process, the semi-finished product having a residue formed during the dry etching process; placing the semi-finished product in a chamber having an inlet and an outlet; introducing an SF₆ gas into the chamber via the inlet to effect a reaction between the SF₆ gas and the residue so as to produce a reaction gas; and discharging any remaining SF₆ gas and the reaction gas out of the chamber via the outlet.

The SF₆ gas can completely react with the residue from the dry etching process and results residue gas pumped out by a vacuum system. It can entirely eliminate the residue over the contact hole and on the inside surface of the dry etching chamber, and can avoid electrical connection errors and improve the efficiency of manufacture. It also can clean the dry etching chamber and prolong the use life of the dry etching chamber.

Other advantages and novel features of preferred embodiments will become more apparent from the following detailed description when taken in conjunction with the accompanying drawings.

### BRIEF DESCRIPTION OF THE DRAWINGS

FIG. 1 to FIG. 5 are schematic, cross-sectional views showing successive stages in a method for forming a source electrode and a drain electrode by a dry etching process in accordance with a first embodiment of the present invention.

FIG. 6 to FIG. 10 are schematic, cross-sectional views showing successive stages in a method for forming a gate electrode by a dry etching process in accordance with a second embodiment of the present invention.

FIG. 11 to FIG. 13 are schematic, cross-sectional views showing successive stages in a conventional process for post-treatment of a semi-finished product after a dry etching process.

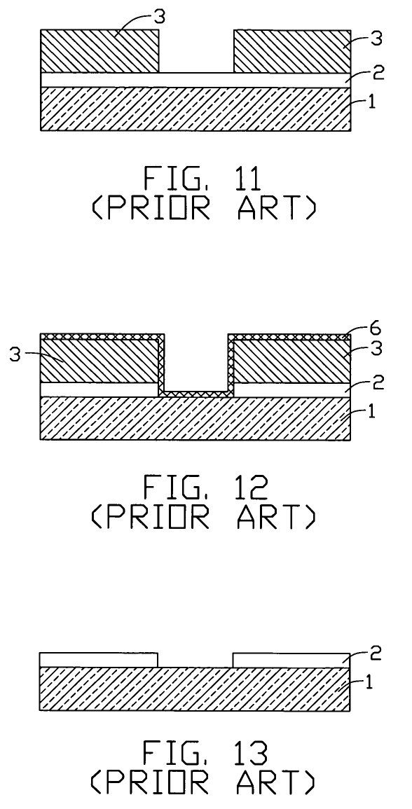

### DETAILED DESCRIPTION OF PREFERRED EMBODIMENTS

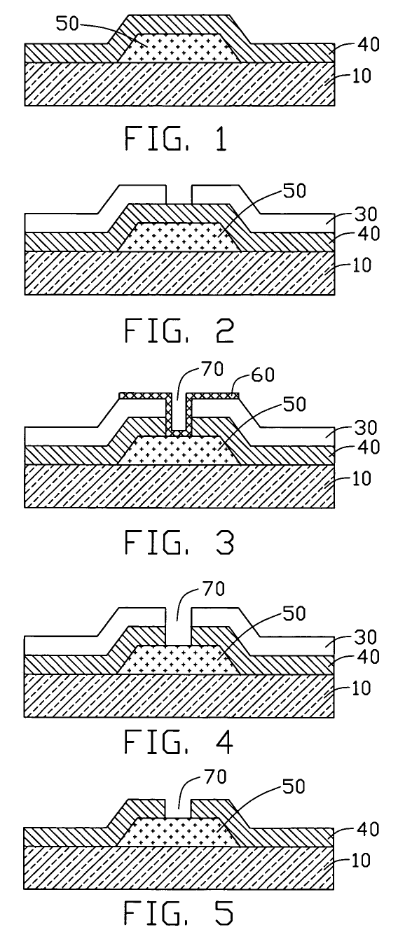

FIG. 1 to FIG. 5 illustrate successive stages in a method for forming a source electrode and a drain electrode by a dry etching process in accordance with a preferred embodiment of the present invention.

As shown in FIG. 1, a source-drain electrode metal layer 50 is formed on a glass substrate 10. A passivation layer 40 is formed on and covers the source-drain electrode metal layer 50.

As shown in FIG. 2, a photo resist layer 30 is formed on the passivation layer 40. The photo resist layer 30 is exposed using a photo mask (not shown), and is developed to form a pattern in the photo resist layer 30.

As shown in FIG. 3, the passivation layer 40 is etched by using a gas containing O₂, SF₆ and CF₄ in a dry etching chamber (not shown) to form a contact hole 70. Meanwhile, a byproduct, i.e. a polymer layer 60, is generally unavoidably formed on an inner surface of the contact hole 70 and on the photo resist layer 30. Further, the byproduct may be also deposited on an inside surface of the dry etching chamber.

The dry etching chamber includes an inlet and an outlet. An SF6 gas is introduced into the dry etching chamber through the inlet. As shown in FIG. 4, the SF₆ gas reacts with the polymer layer 60 and the polymer on the inside surface of the dry etching chamber and produces a SiF₄ gas. Remaining SF₆ gas and the produced SiF₄ gas are discharged out of the dry etching chamber via the outlet, by means of a vacuum system that is connected to the outlet. An amount of the SF₆ gas introduced should be carefully controlled, because the SF₆ gas may further react with the passivation layer 40 and the glass substrate 10 after the polymer layer 60 has been removed.

As shown in FIG. 5, the glass substrate 10 is immersed into a developer solution to remove the photo resist layer 30. The glass substrate 10 and the passivation layer 40 remain. The developer solution may be an acidic solution such as a solution containing tetramethylammonium hydroxide solution, or a neutral solution such as a solution containing polyethylene oxide.

The SF₆ gas can completely react with the polymer formed during the dry etching process and produce silicon tetrafluoride (SiF₄) gas of that is discharged out of the dry etching chamber by the vacuum system. That is, the SF₆ gas can completely remove the polymer from the contact hole 70 and the inside surface of the dry etching chamber. Thus, faulty electrical connections in the finished semiconductor product can be avoided. The SF₆ gas can also clean the dry etching chamber and thus prolong the useful service lifetime of the dry etching chamber.

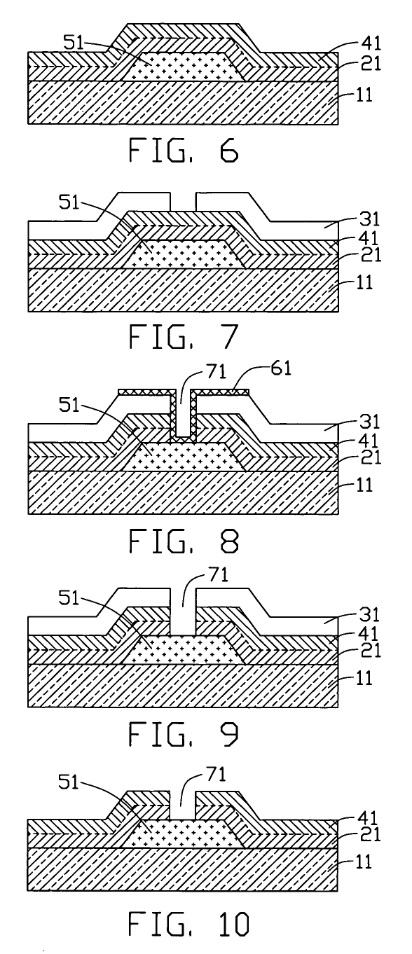

FIG. 6 to FIG. 10 show successive stages in a method for forming a gate electrode by the dry etching process. The method is similar to the above-described method for forming a source electrode and a drain electrode.

As shown in FIG. 6, a gate electrode metal layer 51 is deposited on a glass substrate 11, and an isolation layer 21 and a passivation layer 41 are sequentially deposited on the glass substrate 11 having the gate electrode metal layer 51. Referring to FIG. 7, a patterned photo resist layer 31 is formed on the passivation layer 41 using a photo mask. Referring to FIG. 8, a pattern 71 is defined by a dry etching process, with a polymer residue layer 61 being formed. Referring to FIG. 9, the polymer residue layer 61 is then removed by a post-treatment process using an SF₆ gas. Referring to FIG. 10, the remaining portions of the photo resist layer 31 are then removed.

It should be noted that the inventive post-treatment process can be applied to not only the manufacturing of electrodes of transistors, but also to the manufacturing of other semiconductor products where removal of polymer residue is necessary or desirable.

It is to be understood, however, that even though numerous characteristics and advantages of the embodiments have been set out in the foregoing description, together with details of the functions of the embodiments, the disclosure is illustrative only, and changes may be made in detail to the full extent indicated by the broad general meaning of the terms in which the appended claims are expressed.

What is claimed is:

1. A method for post-treatment of a semi-finished product after a dry etching process, comprising the steps of:
providing the semi-finished product after completion of a dry etching process, the semi-finished product having a residue formed during the dry etching process;
placing the semi-finished product in a chamber having an inlet and an outlet;
introducing a sulfur hex fluoride (SF₆) gas into the chamber via the inlet to effect a reaction between the SF₆ gas and the residue so as to produce a reaction gas; and
discharging any remaining SF₆ gas and the reaction gas out of the chamber via the outlet.

2. The method as claimed in claim 1, wherein the semi-finished product is treated in the chamber during the dry etching process.

3. The method as claimed in claim 2, wherein the outlet is connected to a vacuum system, and any remaining SF₆ gas and the reaction gas are discharged by means of the vacuum system.

4. The method as claimed in claim 1, wherein the semi-finished product comprises a substrate, a semiconductor layer having a pattern defined by the dry etching process formed on the substrate, and a photo resist layer formed on the semiconductor layer.

5. The method as claimed in claim 4, further comprising the step of removing the photo resist layer after discharging any remaining SF₆ gas and the resultant gas.

6. The method as claimed in claim 5, wherein the step of removing the photo resist layer comprises immersing the substrate into a developer solution to remove the photo resistant layer.

7. A method for manufacturing a semiconductor product, comprising the steps of:
forming a semiconductor layer on a substrate;
forming a patterned photo resist layer on the semiconductor layer using a mask;
treating the semiconductor layer by way of a dry etching process using a gas containing O₂, SF₆ and CF₄, whereby a residue is produced;
removing the residue by using an SF₆ gas; and
removing the photo resistant layer.

8. The method as claimed in claim 7, wherein the semiconductor layer is treated in a dry etching chamber.

9. The method as claimed in claim 8, wherein the dry etching chamber comprises an inlet and an outlet.

10. The method as claimed in claim 9, wherein the outlet is connected to a vacuum system, and the vacuum system discharges any remaining SF₆ gas and a reaction gas out of the dry etching chamber via the outlet.
